(19) United States
(12) Patent Application Publication
(10) Pub. No.: US 2013/0244047 A1
(43) Pub. Date: Sep. 19, 2013

(54) FILM OR PLATE

(71) Applicants: Alexander Antonius Marie Stroeks, Echt (NL); Katarina Tomic, Echt (NL)

(72) Inventors: Alexander Antonius Marie Stroeks, Echt (NL); Katarina Tomic, Echt (NL)

(73) Assignee: DSM IP ASSETS B.V., Heerlen (NL)

(21) Appl. No.: 13/806,927

(22) PCT Filed: Jun. 21, 2011
(86) PCT No.: PCT/EP2011/060369

§ 371 Date: May 23, 2013

(30) Foreign Application Priority Data
Jun. 23, 2010 (EP) 10167039.6
Sep. 16, 2010 (EP) 10177164.0

(51) Int. Cl. C08L 77/06; B32B 27/08; B32B 27/34

(52) U.S. Cl. CPC C08L 77/06; B32B 27/34; B32B 27/08
USPC 428/475.5; 528/335; 525/420; 428/474.4

(57) ABSTRACT

Film or plate containing a polyamide having monomer units of butane-1,4-diamine and monomer units of decanedioic acid (PA410). In a preferred embodiment the film or plate contains PA410 and at least one further polymer.

The invention relates to a film or a plate containing a polyamide.

Films and plates of polyamides are widely used. The films and plates have excellent properties, like for example good mechanical properties and good optical properties, which make the films and plates highly suitable for producing packaging of all kind of products, especially for food products. Although the films and plates of nylon have good barrier properties, there is a need to improve these properties. This will make it for example possible to make the films and plates thinner.

Object of the present invention therefore is to provide a film or a plate that contains a polyamide, which film or plate shows improved barrier properties.

Surprisingly this object is obtained, if the film or plate contains a polyamide having monomer units of butane-1,4-diamine and monomer units of decanedioic acid. A polyamide having monomer units of butane-1,4-diamine and monomer units of decanedioic acid will hereafter also be referred to as PA410.

The films and plates containing the PA410 show improved barrier properties to protect food. The films and plates show especially good barrier properties for organic compounds containing hydroxyl groups, for example alcohols like ethanol. This makes the film or plate also well suitable for the production of packaging for fuels, especially biofuel. It will also be possible to store for example food for a longer period, without loosing taste or flavor.

Another advantage is that films and plates are obtained that show stabile oxygen permeability while increasing the humidity. This allows for flexible designs. Yet another advantage is that the films and plates exhibit high puncture resistance. This property is especially important when the films and plates are used for packaging in order to avoid damage to the contents, such as food or fuel.

Films and plates are bodies that have a width and a length which are several times larger than their thickness. Although the difference between films and plates is arbitrary, often it is assumed that films have a relatively low thickness, so that the film is so flexible that it can be coiled up. Plates have a larger thickness, so that they cannot be coiled up, or can only be coiled up with a high radius, for example a radius of at least 300 mm, since otherwise the plate will undergo permanent deformation or it will break. In this patent application it is assumed that the films have a thickness up to 2 mm and plates have a thickness of above 2 mm up to for example 20 mm. The film can for example be a monolayer or a multilayer film. When the film is a multilayer, the multilayer preferably comprises a layer of polyolefin, a tie layer and at least one layer of a polymer composition containing PA410. The polyolefin is for example polyethylene or polypropylene. It is possible that the film or plate consists of a polymer composition that comprises PA410 as the sole thermoplastic polymer in the polymer composition. Preferably the film or plate contains at least one further polymer. In one embodiment the film or plate consists of a polymer composition that contains PA410 and at least one further polymer. In one further embodiment the film or plate comprises at least one layer of a polymer composition containing PA410 and at least one layer of a polymer composition containing the further polymer.

As a further polymer the polymer composition suitably contains other aliphatic polyamides such as for example PA6, PA66, (semi-)aromatic polyamides such as for example PAI-6T, MXD6, polyesters such as for example polyethylene terephthalate (PET) and polyethylene naphthalate (PEN), ethylene vinylalcohol copolymer (EVOH) and polyolefins, such as PE and PP. Tie-layers may be present to obtain sufficient adhesion between layers containing PA410 and the other layers.

Preferably the film or plate contains at least one layer of a polymer composition comprising PA410 and a further polyamide.

An advantage is that films and plates are obtained that have improved barrier properties in view of films and plates from known polyamide compositions, but are yet economically to produce. Another important improvement is that the films and plates according to the invention are no longer fully based on fossil carbon, since PA410 may be at least partly based on renewable resources. This is especially an advantage, even if the polymer composition of the film or the plate only contains a fraction of PA410 and also a further polyamide. Packing that is produced from the films are in generally used only ones as one-way packaging. Therefore these products contribute strongly to the production of green house gases. Replacing the further polyamides by PA410 that is at least partly based on monomers originating from natural resources already provides an important decrease in the production of green house gases.

Preferably the polymer composition contains PA6 and/or PA66 as the further polyamide.

A further surprising advantage is that the films and plates have favorable optical properties. The films have a high transparency and a low haze. This is very surprising since films and plates of polymer compositions containing two or more different polymers often show a low level in their optical properties. The films and plates of the present invention however may even have a transparency that is higher than the transparency of the film or plate containing PA6 or PA66 as the sole polymer.

Polyamides made from a diamine and diacid are usually denoted as AABB resin, see for example Nylon Plastics Handbook, Edited by Melvin I. Kohan, Hanser Publishers, 1995, page 5. The nomenclature is adhered to as used in Nylon Plastics Handbook; e.g. PA410 denotes a polyamide with building blocks butane-1,4-diamine and decanedioic acid.

Preferably the polymer composition of the at least one layer containing PA410 and the further polyamide contains 1-50 parts by weight (pbw) of PA410 and 99-50 pbw of the further polyamide, PA410 and the further polyamide add up to 100 parts. More preferably the polymer composition contains 10-40 of PA410 and 90-60 of the further polyamide.

Preferably the polymer composition contains PA410 and the further polyamide as the sole polymers.

Next to PA410 the composition of the films and plates according to the invention might contain further additives, as for example stabilizers, processing adds, nucleation additives. Preferably the composition contains at most 20 pbw of further additives at 100 pbw of PA410 and the further polyamide, more preferably at most 10 pbw, even more preferably at most 5 pbw, most preferably at most 2 pbw.

The polymer composition of the films according to the invention may be produced by making in a first step a dry blend of powder or granules of component PA410, if appropriate the further polyamide and the further additives, the further additives eventually provided as a master batch. Thereafter granulate of the composition might be produced by using an apparatus for melt mixing, for example a twin screw extruder. The granulate of the composition can be fed to an extruder for making the film or the plate. It is also possible to feed the components separately to the extruder as the dry blend.

The films according to the invention may be produced by using the well known processes for producing films, for example the blown film process and the film casting process. Plates may be produced by using a known process for producing plate, for example by extruding a melt via a slit die and finally shaping and cooling the melt between two cooling rolls.

The films according to the invention may be stretched in-plane. Stretching may be performed in a biaxial planar fashion, either in a sequential or in a simultaneous manner. Surprisingly it has been found that films according to the invention can easily be stretched, which allows for fast processing speeds. Furthermore, the films may be exposed to a heat set step.

In case a multilayer film or plate is produced, an extruder for that purpose is used.

If the films are produced by the blown film process, the so obtained tubular films may be further processed into bags, preferably for use as packaging of food. Films obtained by the film casting process may be welded into tubes in a first step and being processed into bags after that.

The films may further advantageously be used as a substrate material flexible circuit boards (FCB) as these show improved dimensional stability, or as cover film for solar cells.

From the plates packaging may be produced by deep drawing processes. It is for example possible to produce a box, a bottle and a lid, for example to be used as food packaging. It is also possible to produce in that way two halves of a container that are welded together, for example to produce a fuel container.

### EXAMPLES

Amounts are denoted in wt % with respect to the total amount of polyamides in the composition, unless denoted otherwise.

### Viscosity Number (VN)

The viscosity number was determined according to ISO 307, version 2007, by dissolving the PA410 samples in formic acid (90 wt. %) in a concentration of 0.005 g/ml and determining of the viscosity number by an Ubelohde viscometer by measuring at 25° C. the times of flow of the solvent (t0) and of the solution (t1) and calculating the viscosity number by the formulae VN=[(t1/t0)−1]×200 ml/gram.

### Compounds Used

1,10-decanedioic acid, delivered by Dong Fang from China.

Butane-1,4-diamine, delivered by DSM, the Netherlands.

### Production of PA410

350 grams of 1.10-decanedoic acid, 157 grams of butane-1,4-diamine and 420 grams of water are stirred in an autoclave for 30 minutes at 90° C. to obtain a solution of the salt of the diamine and the acid in a concentration of 55 wt. % in water. Then water is removed by first raising the temperature in 10 minutes to 150° C., removing about half of the amount of water under distillation and then raising the temperature to 150° C. and further removing water through distillation, to obtain a concentrated solution containing 6 wt. % of water. Then the autoclave is closed and the temperature in the autoclave is raised until 200° C. The pre-polymerization is performed during 30 minutes at the same temperature, after which the content of the autoclave is flashed in a nitrogen atmosphere and the prepolymer was granulated and cooled.

The granules of the pre-polymer were placed in a tumble dried and post-condensed at a temperature of 220° C. in a nitrogen/water vapor atmosphere (75/25 wt. %) for 48 hours. The obtained PA410 had a VN of 179 ml/g. Also PA410 with a VN of 150 ml/g was obtained. All films comprising PA410 were prepared with PA410 having a VN of 150 ml/g, unless stated otherwise.

### Optical Transparency

### Transmittance and Haze Measurements

### Examples 1 to 14 and Comparative Examples A-D

Transmission experiments were performed at 23° C. at a humidity of 50% on cast films of 50 micrometer. A blank measurement was performed, without a sample and the transmitted light to the detector at each wavelength was set to 100%. A sample was placed and the measurement was repeated. The recorded light transmission at each wavelength was normalized to the blank measurement and so a transmittance value in % was obtained. A film of 100 wt % PA410 was measured (example 1) as well as blends with PA6 and respectively 1 wt %, 5 wt %, 10 wt %, 25 wt % and 50 wt % PA410 (examples 2 to 6 respectively), based on the total amount of polyamides. Also a blend with PA66 and PA410 was measured (example 7). As a comparison, two blends with PA6 and 1 and 10 wt % PA610 respectively were measured (comparative examples A and B).

Haze measurements were also performed according to ASTM standard D 1003-00, Procedure B on 50 micrometer films. Four transmission spectra of the sample in the spectral range between 780 nm and 380 nm were acquired. Each of the four measurements required a different configuration of the integrating sphere, as described in Table 1.

TABLE 1
Overview of measurements to determine haze

| | | Reflectance | |
|---|---|---|---|
| | Sample in | standard | |
| Measurement | position | in position | Quantity represented |
| T1 | no | yes | incident light |
| T2 | yes | yes | total light transmitted by |
| | | | specimen |
| T3 | no | no | light scattered by instrument |
| T4 | yes | no | light scattered by instrument |
| | | | and specimen |

The percent haze is then calculated as follows:

Haze=[(T4/T2)−(T3/T1)]×100%

The haze was determined of a film of 100 wt % PA410 (example 8) as well as blends with PA6 and respectively 1 wt %, 5 wt %, 10 wt %, 25 wt % and 50 wt % PA410 (examples 9 to 13), based on the total amount of polyamides, which were cast to a film of 50 micrometer. Also a blend with PA66 and PA410 was measured (example 14). As a comparison, two blends with PA6 and 1 and 10 wt % PA610 respectively were measured (comparative examples C and D).

### Results:

Example 1 showed a transmittance of at least 91%. Examples 2 to 5 showed a difference in transmittance of less than 0.2% with respect to pure PA 6 films as well as to a 100 wt % PA410 (example 1). The wavelengths for visible light the transmittance was also for the blends at least 91%. A similar effect was observed for films comprising the blend of polyamide 6,6 and polyamide 4,10, namely example 7. Differences in haze of less then 0.6% were observed for the 100 wt % PA410 film (example 8), as well as the blends of PA6 and PA410, examples 9 to 13, with respect to pure PA6 film. Moreover, for all examples a haze of less then 1% was observed for wavelengths between 350 and 1150 nm, which shows a very high transmittance of light. Similar results were also observed for example 14, namely the blend comprising PA6,6 and PA410. These results clearly show that with films according to the invention good optical transparency can be obtained and that upon increasing the amount of PA410 in a blend, the optical transparency remains good.

Comparative measurements with blends of PA610 and PA6 showed upon increase of the amount of PA6,10 in the blend a clear decrease in transmittance (comparative examples A and B), as well as an increase in haze (comparative examples C and D). This indicates that a film of a blend comprising polyamide 6,10 is less beneficial than a film according to the present invention.

### Oxygen Permeability

### Examples 15 to 22

### Comparative Example F

Oxygen permeability measurements were also performed on 50 micrometer films for blends comprising polyamide 6 and 1 wt %, 5 wt % and 10 wt % of PA410 respectively (examples 15 to 17). Surprisingly, the oxygen permeability under dry conditions remains sufficiently for these blends, compared to the oxygen permeability of a 100 wt % PA6 film. Under humid conditions, 85% relative humidity, the oxygen permeability even decreased performed for blends comprising polyamide 6 and 1 wt %, 5 wt % and 10 wt % of PA410 respectively (examples 18 to 20). The oxygen permeability for 100 wt % PA410 film under dry conditions (example 21) was 4.1 ccmm/m² day, which showed to be lower than for a 100 wt % PA610 film (comparative example E), which showed to be 6.8 ccmm/m² day. Oxygen permeability for 100% PA410 films at 85% relative humidity was 3.67 ccmm/m² day (example 22), which is comparable for 100% PA6 film, which was 3.24 ccmm/m² day (comparative example F). Surprisingly, when extrapolating the oxygen permeability as function of relative humidity, it showed that a film of 100% PA410 exhibits lower oxygen permeability than a film of 100% PA6, when the relative humidity is 100%. This is advantageous for film applications where moisture is present.

### Puncture Resistance

### Example 23

### Comparative Example G

Puncture resistance was measured on films according to the invention. Round samples with a diameter of 70 mm were punched from the supplied films. These round samples were clamped on a span tool with an inner diameter of 20 mm. A cylindrical indenter with a diameter of 6 mm and a top radius of 7 mm was pushed through the sample at a constant speed of 50 mm/min until break. The tests were performed on a standard tensile testing machine (Zwick Z1474), equipped with a 200 N load cell for the load measurement. The indenter displacement was determined by the traverse displacement. The measurements were performed at 23° C. and 50% relative humidity, and were carried out in six fold. The normalized energy to break (N mm/μm) was determined by dividing the area underneath the load-displacement curve by the thickness of the film. Results are shown in Table 2.

TABLE 2
Puncture resistance

| | Fₘₐₓ/thickness | s.d. | W to Fₘₐₓ | s.d. |
|---|---|---|---|---|
| | [N/μm] | [N/μm] | [Nmm/μm] | [Nmm/μm] |
| Example 23 | 0.84 | 0.05 | 9.86 | 1.09 |
| 100% PA410 | | | | |
| (VN 170) | | | | |
| Comparative | 0.93 | 0.07 | 10.23 | 1.43 |
| example G | | | | |
| PA6 | | | | |

Fₘₐₓ/thickness - normalized force
W - energy at break

Surprisingly, the puncture resistance for 100% PA-410 film is comparable to 100% PA-6 film. Together with the other good mechanical properties, a high puncture resistance is beneficial for food applications for film and plates.

1. Film or plate containing a polyamide having monomer units of butane-1,4-diamine and monomer units of decanedioic acid (PA410).

2. Film or plate according to claim 1, characterized in that the film or plate contains PA410 and at least one further polymer.

3. Film or plate according to claim 2, characterized in that the film or plate consists of a polymer composition that contains PA410 and the further polymer.

4. Film or plate according to claim 2, characterized in that the film or plate comprises at least one layer of a polymer composition containing PA410 and at least one layer of a polymer composition containing the further polymer.

5. Film or plate according to claim 2, characterized in that the film or plate contains at least one layer of a polymer composition containing PA410 and a further polyamide.

6. Film or plate according to claim 5, characterized in that the further polyamide is PA6 or PA66.

7. Film or plate according to claim 5, characterized that the polymer composition of the at least one layer contains 1-50 pbw (parts by weight) PA410 and 99-50 pbw of the further polyamide, PA410 and the further polyamide add up to 100 pbw.

8. Packaging produced of the film or plate according to claim 1.

9. Use of the film according to claim 1 as a cover film for solar cells.

10. Use of the film according to claim 1 as a substrate material for flexible circuit boards.

11. Use of the film according to claim 1 as packaging for food or fuel.
